(19) United States
(12) Patent Application Publication
(10) Pub. No.: US 2004/0181609 A1
(43) Pub. Date: Sep. 16, 2004

(54) Group administration of universal resource identifiers with heirarchical members

(75) Inventors: Cristi Nesbitt Ullmann, Austin, TX (US); Lorin Evan Ullmann, Austin, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, Armonk, NY

(21) Appl. No.: 10/388,978

(22) Filed: Mar. 13, 2003

(51) Int. Cl. G06F 15/16; G06F 15/173

(52) U.S. Cl. 709/245; 709/223

(57) ABSTRACT

Administration of URIs in groups, including creating a group URI, creating a first member URI identifying a first resource, identifying, within the first resource, an embedded hyperlink to a second resource, creating, in dependence upon the embedded hyperlink, a second member URI identifying the second resource, and storing the group URI, the first member URI, and the second member URI. Embodiments include retrieving, in dependence upon the group URI, a plurality of first-tier member URIs, retrieving, in dependence upon the group URI, a plurality of second-tier member URIs associated with at least one first-tier member URI, retrieving a plurality of first-tier resources identified by the first-tier member URIs, retrieving a plurality of second-tier resources identified by the second-tier member URIs, displaying the first-tier resources, and displaying the second-tier resources.

### BACKGROUND OF THE INVENTION

1. Field of the Invention

The field of the invention is data processing, or, more specifically, methods, systems, and products for administration of URIs in groups.

2. Description of Related Art

Handicapped computer users often have limited ability to navigate through a series of links embedded in HTML documents or web pages. It is often physically difficult for handicapped users to perform the tasks of moving interface pointers to web links and invoking the links to move among web pages. Browsers do not support recording series of navigational actions for later playback. Browsers do not support the persistence of playback of navigated links once a browser session is completed.

Browsers do provide storage of single web addresses as bookmarks or favorites listings. In the Netscape Navigator community such single address listings are referred to as ‘bookmarks,’ and they are called ‘favorites’ by users of Microsoft's Internet Explorer. For clarity in this specification, all such single address listings are referred to as ‘bookmarks.’ In current art, however bookmarks are not saved as groups, but rather as single addresses. The locations visited by a user before and after a web address recorded as a bookmark are lost.

In addition, web content providers often cause a newly navigated web page to be displayed in a new instance of a web browser, leaving behind in a first browser the navigation history of the user's current session and disabling the ‘Back’ button for the new instance of the browser. The ‘back’ button in the new browser is not effective to return the user to the window from which the web page was ordered. The effect, for example, is that a user reading a book cannot turn the page back to page two when reading page three. In order to return to a previous page in the book example, a user must terminate a present instance of the browser or otherwise bring a previous instance of the browser into focus in, for example, another window or frame. This is inconvenient for all users, but it is very inconvenient for disabled users.

It would be advantageous if there were methods and systems for a user to record a number of related navigated links so that a handicapped user could playback the navigation among the links with a minimum of interface tasks.

### SUMMARY OF THE INVENTION

Exemplary embodiments of the invention include methods for administration of URIs in groups. Exemplary embodiments include creating a group URI, creating a first member URI identifying a first resource, and identifying, within the first resource, an embedded hyperlink to a second resource. Such embodiments include creating, in dependence upon the embedded hyperlink, a second member URI identifying the second resource, and storing the group URI, the first member URI, and the second member URI.

In exemplary embodiments of the invention, creating first member URI identifying a first resource includes creating a first-tier member URI. In such embodiments, creating, in dependence upon the embedded hyperlink, a second member URI identifying the second resource includes creating a second-tier member URI. In typical embodiments, storing the group URI, the first member URI, and the second member URI includes associating the second-tier member URI with the first-tier member URI.

Exemplary embodiments of the invention include retrieving, in dependence upon the group URI, a plurality of first-tier member URIs, retrieving, in dependence upon the group URI, a plurality of second-tier member URIs associated with at least one first-tier member URI, and retrieving a plurality of first-tier resources identified by the first-tier member URIs. Such embodiments include retrieving a plurality of second-tier resources identified by the second-tier member URIs, displaying the first-tier resources, and displaying the second-tier resources.

Exemplary embodiments of the invention include creating an instance of a first-tier data communications client and creating an instance of a second-tier data communications client. Such embodiments include storing the plurality first-tier member URIs in navigation memory of the first-tier data communications client and storing the plurality of second-tier member URIs in navigation memory of the second-tier data communications client. In typical embodiments, identifying an embedded hyperlink within the first resource includes finding a start tag of an anchor element and reading a target identifying the second resource.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a data flow diagram of an exemplary embodiment of a method for administration of URIs in groups in accordance with the present invention.

FIG. 2 is a data flow diagram of a further exemplary embodiment of a method for administration of URIs in groups in accordance with the present invention.

FIG. 3 is a data flow diagram of a still further exemplary embodiment of a method for administration of URIs in groups in accordance with the present invention.

FIG. 4 is a data flow diagram of an even further exemplary embodiment of a method for administration of URIs in groups in accordance with the present invention.

FIG. 4A is a data flow diagram of an even further exemplary embodiment of a method for administration of URIs in groups in accordance with the present invention.

FIG. 4B is a data flow diagram of a method of identifying an embedded hyperlink and method of creating a second member URI in accordance with the present invention.

FIG. 5 is a data flow diagram of still a further exemplary embodiment of a method for administration of URIs in groups in accordance with the present invention.

FIG. 5A is a data flow diagram of an exemplary method for administration of URIs in groups in accordance with the present invention.

FIG. 6 is a block diagram illustrating aspects of browser user interfaces useful in various exemplary embodiments of the present invention.

### DETAILED DESCRIPTION OF EXEMPLARY EMBODIMENTS

### Introduction

The present invention is described to a large extent in this specification in terms of methods for administration of URIs in groups. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute,” unless the context indicates otherwise, generally are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.” Aggregates of records are referred to as “tables” or “files.” Aggregates of files are referred to as “databases.”

“Anchor element” refers to a markup language element that identifies and implements a ‘link’ or ‘web link’ or ‘hyperlink.’ Links are the basic hypertext construct, the central function of the web. A common example form of an anchor element is:

<a href=“\\SrvrX\DocY”> Press Here For Document Y </a>

This example anchor element includes a start tag <a>, and end tag </a>, an href attribute that identifies the target of the link as a document named ‘DocY’ on a web server named ‘SrvrX,’ and an anchor. The “anchor” is the display text that is set forth between the start tag and the end tag. That is, in this example, the anchor is the text “Press Here For Document Y.” In typical usage, the anchor is displayed in highlighting, underscored, inverse, specially colored, or some other fashion setting it apart from other screen text and identifying it as an available hyperlink. In addition, the screen display area of the anchor is sensitized to user interface operations such as GUI pointer operations such as mouseclicks. In typical operation, a user points to the anchor with a mouse pointer or other GUI pointer, clicks on the anchor to invoke the link, and the browser then retrieves and displays Document Y from server SrvrX. The “anchor element” is the entire markup from the start tag to the end tag.

“Browser” means a web browser, a software application for locating and displaying web pages. Browsers typically comprise both a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML and HDML.

CGI means “Common Gateway Interface,” a standard technology for data communications of resources between web servers and web clients. More specifically, CGI provides a standard interface between servers and server-side ‘gateway’ programs which administer actual reads and writes of data to and from files systems and databases. The CGI interface typically sends data to gateway programs through environment variables or as data to be read by the gateway programs through their standard inputs. Gateway programs typically return data through standard output. It is typically a gateway program that provides a MIME type in a return message header advising a server, and eventually therefore a browser or other communications client, of the type of data returned from CGI gateway programs.

A “data communications client” is any data communications software capable of performing network-based data communications, including email clients, browsers, and special purpose software systems. In typical embodiments of the present invention, data communications clients run on “data communications devices,” which are any automated computing machinery capable of supporting data communications including web-enabled devices and handheld devices including telephones, web-enabled personal digital assistants, laptop computers, handheld radios, and communicators.

An “embedded hyperlink” is a reference to a resource name or a resource network address that is embedded within another resource. Invoking the embedded hyperlink allows the named resource or resource network address to be accessed.

“HTML” stands for ‘HypterText Markup Language,’ a standard markup language for displaying web pages on browsers.

“HTTP” stands for ‘HyperText Transport Protocol,’ the standard data communications protocol of the World Wide Web.

A “hyperlink,” also referred to as “link” or “web link” is a reference to a resource name or network address which when invoked allows the named resource or network address to be accessed. Often the hyperlink identifies a network address at which is stored a web page. As used here, “hyperlink” is a broader term than “HTML anchor element.” Hyperlinks include links effected through anchors as well as URIs invoked through ‘back’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output as well.

“MIME” means Multipurpose Internet Mail Extensions. MIME is a standard that extends the format of Internet mail and other Internet documents to allow non-US-ASCII textual messages, non-textual messages, multipart message bodies, and non-US-ASCII information in message headers. MIME allows mail messages to contain multiple objects in a single document, text having unlimited line length or overall length, character sets other than ASCII (allowing non-English language document), multi-font documents, binary or application specific files, and images, audio, video and multi-media messages. MIME is originally an email standard, but it is used in web communications also. MIME is defined by an Internet standard document called “RFC 1521.” The MIME standard is written to allow MIME to be extended in certain ways, without having to revise the standard. MIME specifies sets of values that are allowed for various fields and parameters. This provides a procedure for extending these sets of values by registering them with an entity called the Internet Assigned Numbers Authority (IANA).

MIME includes a header field called ‘content-type’ that describes the data contained in a MIME document so that communications clients such as email applications and browsers can pick an appropriate mechanism to present the data to the user, or otherwise deal with the data appropriately. The content-type header field is used to specify the nature of data in the body or body part, by giving type and subtype identifiers. The top-level content-type is used to declare the general type of data, while the subtype specifies a specific format for that type of data. Thus, a content-type of image/xyz is enough to tell a mail reader or a browser that the data is an image, even if the mail reader has no knowledge of the specific image format xyz.

In this specification, a MIME content-type is generally referred to as a “MIME type.” There are many MIME types. Here is an example listing of several representative MIME types in the standard form “top-level content-type/subtype” along with a description of the kind of data represented by each MIME type:

| Mime Type | Description |
|---|---|
| text/html | HTML text data - RFC 1866 |
| text/plain | plain text documents, program listings |
| text/enriched | enriched text markup - RFC 1896 |
| image/gif | GIF image file |
| image/jpeg | JPEG image file |
| image/tiff | TIFF image file |
| audio/basic | “basic” audio, 8-bit u-law PCM |
| audio/x-wav | Microsoft audio |
| audio/z-mpeg | MPEG audio |
| video/mpeg | MPEG video |
| video/quicktime | Macintosh Quicktime video |
| application/postscript | PostScript file |
| application/zip | zip data compression archive |
| application/javascript | Javascript program |
| application/ms-word | Microsoft Word document |
| application/ms-powerpoint | Microsoft PowerPoint presentation |
| application/ms-excel | Microsoft Excel spreadsheet |
| multipart/mixed | document or message with multiparts |

“Network” is used in this specification to mean any networked coupling for data communications among computers or computer systems. Examples of networks useful with the invention include intranets, extranets, internets, local area networks, wide area networks, and other network arrangements as will occur to those of skill in the art.

“Resource” means any aggregation of information administered over networks by various embodiments of the present invention. Network communications protocols generally, for example, HTTP, transmit resources, not just files. A resource is an aggregation of information capable of being identified by a URI or URL. In fact, the ‘R’ in ‘URI’ is ‘Resource.’ The most common kind of resource is a file, but a resources include dynamically-generated query results, the output of a CGI scripts, dynamic server pages, documents available in several languages, and so on. It may sometimes be useful to think of a resource as similar to a file, but more general in nature. Files as resources include web pages, graphic image files, video clip files, audio clip files, files of data having any MIME type, and so on. As a practical matter, most HTTP resources are currently either files or server-side script output. Server side script output includes output from CGI programs, Java servlets, Active Server Pages, Java Server Pages, and so on.

“Server” in this specification refers to a computer or device comprising automated computing machinery on a network that manages network resources. A “web server” in particular is a server that communicates with browsers by means of HTTP in order to manage and make available to networked computers markup language documents and digital objects.

A “target attribute” is an HTML attribute that can be set as an attribute an HTML anchor element. The general use of the target attribute is to specify the name of a frame where a linked resource (new document, file, web page, or other resource) is to be opened. A more particular use of the target element is to cause a user agent, that is usually a browser of some kind, to open a linked resource in a new, unnamed window. This is accomplished in HTML, for example, simply by setting a target attribute value equal to ‘_blank’ in any anchor element. ‘_blank’ is a standard target value in HTML that instructs a browser of other user client to display the resource linked through the anchor in a new window or frame. That is, use of “target=_blank” as an anchor attribute that typically in practical operation is a way of displaying a linked resource in a new instance of a browser, cutting off navigation history of the user's current session and disabling the ‘Back’ button for the new instance of the browser.

A “URI” or “Universal Resource Identifier” is an identifier of a named object in any namespace accessible through a network. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URLs directed to particular resources, such as particular HTML files, JPEG files, or MPEG files, typically include a path name or file name locating and identifying a particular resource in a file system coupled to a network. To the extent that a particular resource, such as a CGI file or a servlet, is executable, for example to store or retrieve data, a URI often includes query parameters, or data to be stored, in the form of data encoded into the URI Such parameters or data to be stored are referred to as ‘URI encoded data.’ “URI encoded data” is data packaged in a URI for data communications. In the case of HTTP communications, the HTTP GET and POST functions are often used to transmit URI encoded data. In this context, it is useful to remember that URIs do more than merely request file transfers. URIs identify resource on servers. Such resource may be files having filenames, but the resources identified by URIs also include, for example, queries to databases. Results of such queries do not necessarily reside in files, but they are nevertheless data resources identified by URIs and identified by a search engine and query data that produce such resources. An example of URI encoded data is:

http://www.foo.com/cgi-bin/MyScript.cgi?field 1=value1&field2=value2

This is an example of URI encoded data, which is how HTML forms typically are submitted over the web using HTTP GET request messages. This method using the GET message is useful when the amount of data to be encoded is fairly small. For larger amounts of data, it is more common to use HTTP POST messages for form submissions.

More specifically, the entire example above is a URI bearing encoded data, and the encoded data is the string “field1=value1&field2=value2.” The encoding method is to string field names and field values separated by ‘&’ and “=” with spaces represented by ‘+.’ There are no quote marks or spaces in the string. Having no quote marks, spaces are encoded with ‘+.’ For example, if an HTML form has a field called “name” set to “Lucy”, and a field called “neighbors” set to “Fred & Ethel”, the data string encoding the form would be:

name=Lucy&neighbors=Fred+%26+Ethel

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Although standards today are written on the basis of URIs, it is still common to such see web-related identifiers, of the kind used to associate web data locations with network addresses for data communications, referred to as “URLs.” In this specification, we refer to such identifiers generally as URIs.

“World Wide Web,” or more simply “the web,” refers to a system of internet protocol (“IP”) servers that support specially formatted documents, documents formatted in markup languages such as HTML, XML, WML, or HDML. The term “Web” is used in this specification also to refer to any server or connected group or interconnected groups of servers that implement the HyperText Transport Protocol, “HTTP,” in support of URIs and documents in markup languages, regardless whether such servers or groups of servers are coupled to the World Wide Web as such.

“XML” stands for ‘eXtensible Markup Language,’ a language that support user-defined markup including user-defined elements, tags, and attributes. XML's extensibility contrasts with most web-related markup languages, such as HTML, which are not extensible, but which instead use a standard defined set of elements, tags, and attributes. XML's extensibility makes it a good foundation for defining other languages. WML, the Wireless Markup Language, for example, is a markup language based on XML. Modern browsers and other communications clients tend to support markup languages other than HTML, including, for example, XML.

### DETAILED DESCRIPTION

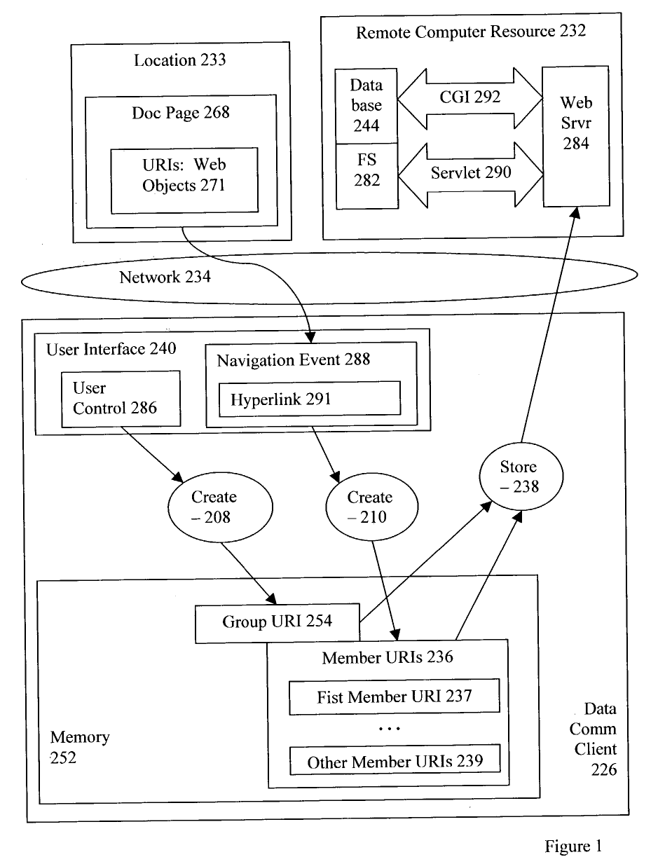

Turning to FIG. 1, a first exemplary embodiment of the present invention is illustrated as a method for administration of URIs in groups. Embodiments of the kind illustrated typically include creating (208), in a group URI-enabled data communications client (226), a group URI (254) identifying a remote computer resource (232) accessible through a computer network (234). We use the term “remote computer resource” to refer to the aggregation of computer resources useful with various embodiments of the present invention to store and retrieve from remote locations group URIs and member URIs. As depicted in FIG. 1, remote computer resources include data communications servers, web servers, database servers, databases, file systems, CGI scripts, Java Server Pages, Microsoft Active Server pages, or any other remote computer resource that will occur to those of skill in the art.

A group URI-enabled data communications client is a data communications client modified to administer group URIs and member URIs in accordance with the present invention. Data communications clients are modified to administer group and member URIs in many ways, all within the scope of the present invention. For example, a data communications client, such as a browser, in some embodiments, is altered at the source-code level, simply expanded and recompiled, to include computer software implementing a method of the present invention. Such embodiments, altered in their own source code, are expected typically to include alternations to administer documents, files, and other resources in dependence upon a MIME type for group URIs.

In other embodiments of group URI-enabled data communications programs, a separate group URI application program is written in the source code of any computer language, such as C, C++, or Java. The separate group URI application program is then compiled and installed as a separate native executable on the same computer with a data communications client. Then a new MIME type, such as ‘application/groupURI,’ is registered with a data communications client such as a browser or email client, and is registered also upon the remote computer resource that stores and serves up the group URIs and member URIs. In this approach to developing a group URI-enabled data communications client, except for registering the new MIME type, the only change needed in the data communications client itself is to install a user interface control, such as a GUI toolbar button or a pull-down menu entry, to invoke the new application. Then the data communications client will invoke the separate group URI application program both upon request of a user and upon receiving from a server a document having a header MIME type entry of ‘application/groupURI.’

Another way to modify a data communication client to implement a method of the present invention is with a plug-in. A “plug-in” is a hardware or software module that adds a specific feature or service to a larger system. For example, there are a number of plug-ins for the popular browsers and email clients such as Netscape Navigator, Microsoft Internet Explorer, and Microsoft Outlook, that enable such data communications clients to display different types of audio or video messages based on MIME types.

More particularly, in embodiments using plug-ins, a plug-in is written in the source code of any computer language, such as C, C++, or Java. The plug-in is then installed in a data communications client such as a browser, and a MIME type for group URIs is registered with, for example, the browser and is registered also upon the remote computer resource that stores and serves up the group URIs and member URIs. The plug-in, when invoked, accesses the user interface through the browser to install its own user controls such as GUI buttons, toolbars, pull down menus, and pull down menu entries. The data communications client invokes the separate group URI application program both upon request of a user, who invokes the plug-in through a user interface control, and upon receiving from a server a document having a header MIME type entry of ‘application/groupURI.’

Described just above are three ways to implement a group URI-enabled data communications client useful in various embodiments of the present invention. Persons of skill in the art will think of other ways to implement such data communications clients, all of which are well within the scope of the present invention.

Embodiments of the kind shown in FIG. 1 generally include creating (210), in response to at least one navigation event (288) invoking a hyperlink (291) to a document page (268) at a network location (233), a member URI (236) identifying the network location (233) of the document page (268). A navigation event is any interface event invoking a hyperlink, including, for example, invocation of a browser ‘back’ button, a ‘forward’ button, an anchor, or entry of a URL or URI in an address field of a browser.

The term “document page” is used to denote a file type broader than a web page. “Web page” denotes markup, hyperlinking documents such as HTML or XML documents served up through HTTP. Document pages of the present invention include document that do not support markup, such as plain text, for example, and do not necessarily support hyperlinking, because a group URI is sometimes created, for example, through use of typed-in URIs or URLs rather than invoked anchors. In addition, document pages of the present invention are often delivered by SMTP, POP, FTP, or some other protocol, not involving the web at all. Many document pages are web pages, of course, but not all of them. Although, the member URI (236) of the method of FIG. 1 identifies a network location of a document page, in various alternate embodiments, the member URI identifies any resource, such as web pages, graphic image files, video clip files, audio clip files, files of data having any MIME type, or any other resource that will occur to those of skill in the art.

Embodiments according to FIG. 1 typically include storing (238), together in the remote computer resource (232), the group URI (254) and the member URI (236). An example of a way to store a group URI and one or more member URIs (ordinarily there will be more than one member URI) is to transmit an HTTP POST request having a URI similar in form to the following, bearing encoded data:

http://www.foo.com/cgi-bin/MyScript.cgi?[attach encoded data here]

And the encoded data in this example is a string of the form:

groupURIname=MyGrpURI-1 &

mbrURI1=http//www.google.com/&

mbrURI1=http//www.msnbc.com/&

mbrURI3=http//www.nsi.com/&

. . .

mbrURI376=http://www.ncsa.uiuc.edu/

The encoded data example is a single long string, broken into several lines in this example to make it a little easier to read. The example implicitly encodes 376 member URIs, but we omitted 372 of them for ease of illustration. This particular example is directed to the web, but it shows how easily a tremendous amount of network navigation can be encoded into a single group URI.

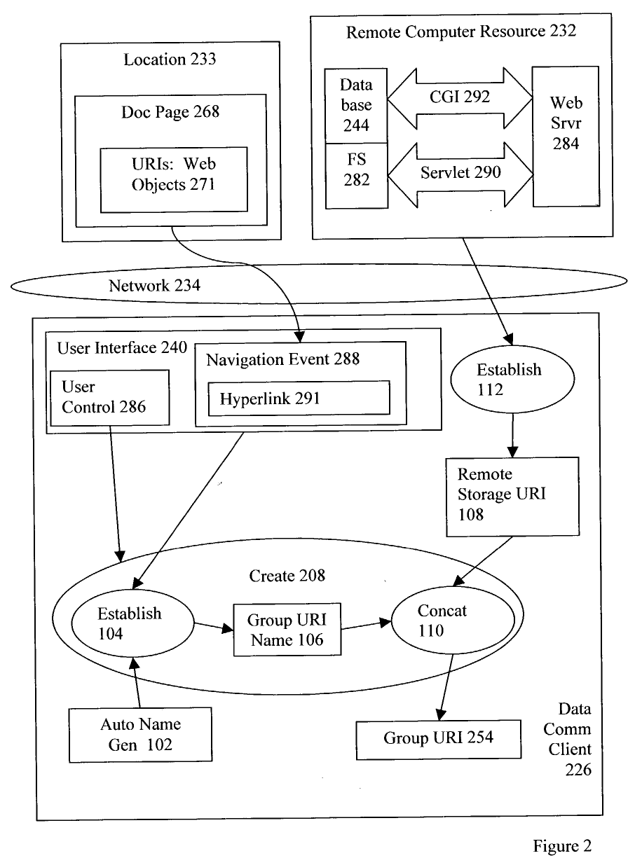

Turning now to FIG. 2, a further exemplary embodiment of the invention is shown as including establishing (112) a remote storage URI (108) that identifies a remote computer resource (232). In such embodiments, creating (208) a group URI (254) typically includes establishing (104) a group URI name (106) for the group URI, and concatenating (110) the group URI name (106) and the remote storage URI (108). In our present example:

http://www.foo.com/cgi-bin/GuriScript.cgi?[attach encoded data here]

the string “http://www.foo.com/cgi-bin/MyScript.cgi” is a remote storage URI. This particular example of a remote storage URI identifies a resource CGI script accessible through an HTTP GET or POST request.

We have named an example CGI script twice, MyScript.cgi and GuriScript.cgi. Perhaps the names sound a little like the scripts are specially written for embodiments of the present invention. They could be, but there is no such requirement in the scope of the present invention. The remote data storage requirements of the present invention in fact are handled in most embodiments by off-the-shelf, as it were, software technology for remote data access including for example, CGI scripts, Java servlets, Java Server Pages, and Active Server Pages.

In our current example, “MyGrpURI-1” is a group URI name. In some embodiments, establishing a group URI name involves automated name generation (102), as for example, through an algorithm and a random number generator. An example of such an algorithm is:

Step 1: generate a random number and convert it to text

Step 2: concatenate the text random number with the string “GURI”

Such a method would generate automated group URI names having the form:

GURI29384

GURI78120

GURI75890

GURI87654

And so on.

Another way to establish a group URI name, for example, is to prompt a user to type in a name and receive the name as text through a user control (286), such as a data entry field, in a user interface (240). Hence a name similar to the one in our example, “MyGrpURI-1.” And in this example, a group URI formed by concatenating (110) a group URI name such as “MyGrpURI-1” and a remote storage URI such as http://www.foo.com/cgi-bin/GuriScript.cgi?, creates a group URI having the form:

http://www.foo.com/cgi-bin/GuriScript.cgi?groupURIname=MyGrpURI-1

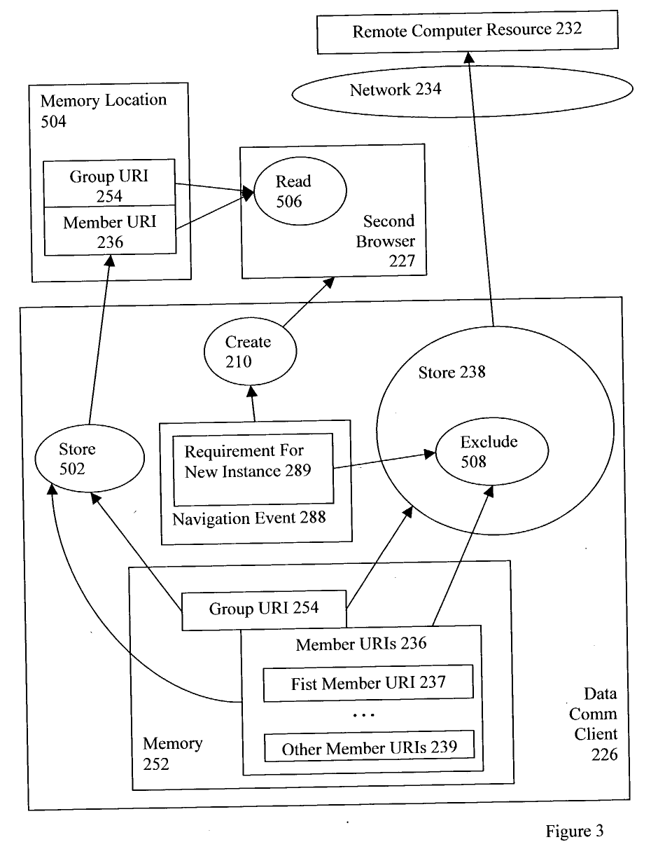

Turning to FIG. 3, a still further exemplary embodiment is shown in which a navigation event (288) invoking a hyperlink includes a requirement (289) to display the document page in a new instance of a data communications client. An example of a hyperlink including a requirement to display a document page in a new instance of a data communications client is an anchor element in an HTML document having a target attribute set to “_blank.” Embodiments according to FIG. 2 typically include storing (502) the group URI (254) and the member URI (236) in a memory storage location (504) in computer memory, in which the memory storage location (504) is accessible to a second instance (227) of the group URI-enabled data communications client.

There are many ways to implement a memory storage location (504) accessible to a second instance of a client. The first instance and the second instance in some embodiments mutually possess a shared memory segment with semaphore-controlled mutually exclusive access. In other embodiments, a memory storage location storage location (504) accessible to a second instance of a client is a predefined file system storage location on a magnetic disk or other form of non-volatile storage. In other embodiments, a memory storage location storage location (504) accessible to a second instance of a client is a predefined environment variable. The usefulness of the memory storage location storage location (504) accessible to a second instance of a client is to flag to the second instance that a group URI recording is underway, so that the second instance simply continues the recording unperturbed.

Exemplary embodiments of the kind shown in FIG. 3 typically include creating (2 10), in response to the navigation event (288), a second instance (227) of the group URI-enabled data communications client, and reading (506) from the memory storage location (504), in the second instance (227) of the group URI-enabled data communications client, at least the group URI (254), and, optionally, the member URI (236). In exemplary embodiments of the kind shown in FIG. 3, storing (238), together in the remote computer resource (232), the group URI (254) and the member URI (236) typically includes storing the member URI including only a URI from the hyperlink, whereby the member URI is stored in a condition that allows display of the document page in the group URI-enabled data communications client independent of any requirement to display the document page in a new instance of a data communications client. The usefulness of storing only a URI from the hyperlink as a member URI is to exclude any requirement for a second instance of the data communication client when the member URI is eventually played back to a disabled user, or any user, so that upon playback, no second instance of the data communications client is created, and any session history and ‘back’ button remain intact and functional. In the case of the anchor element target attribute “_blank,” in the HTML example, such an attribute is excluded from a member URI created from such an anchor element.

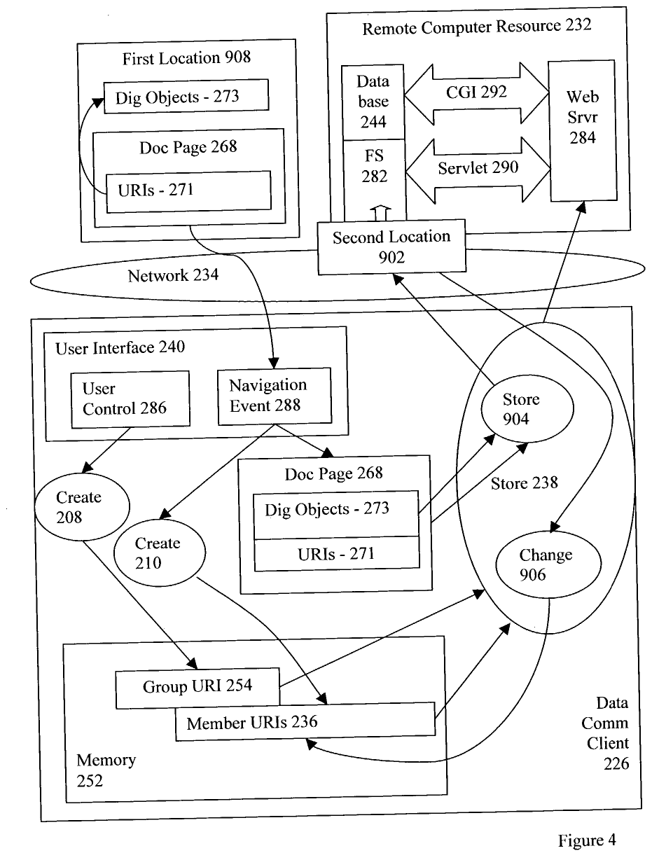

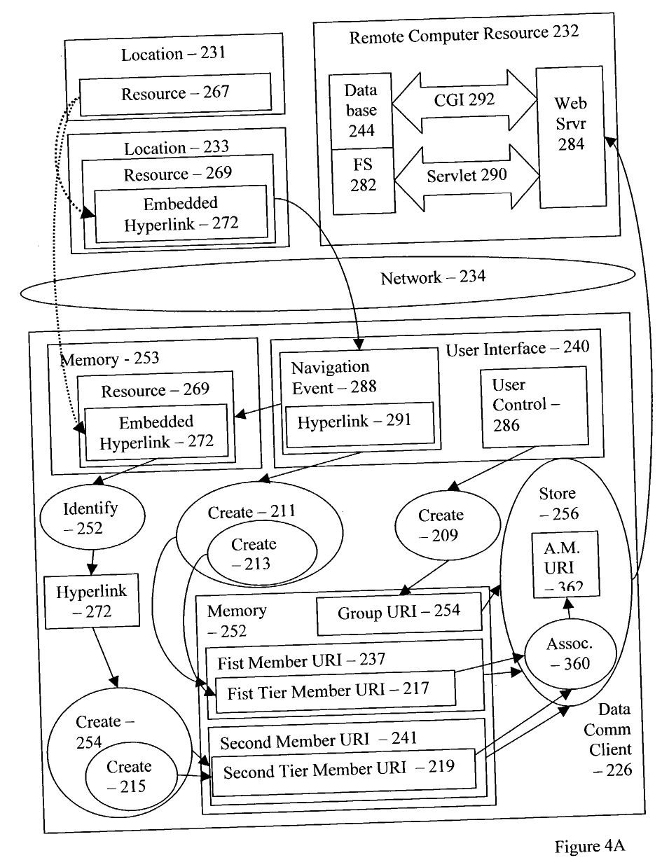

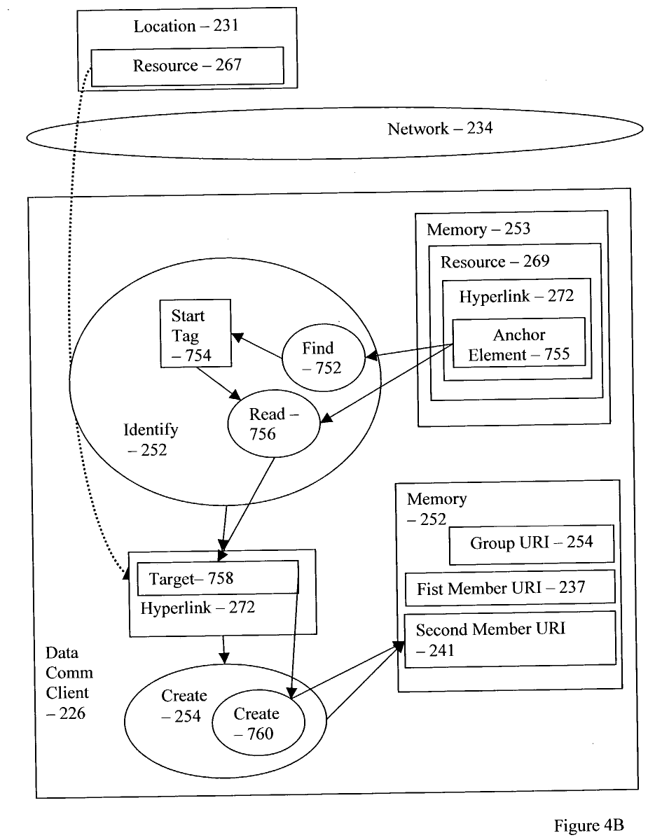

Next we turn to consider the example of a document page, set of document pages, or any other resource for inclusion as member URIs, that a user wishes to remain static. In the case of the web, many web pages change often. Web-based news service change daily or hourly. Commercial sites on the web change often. If a user wishes to freeze a web site for later playback in a group URI, the user must have a way to copy and store the present content of the site away from the manipulations of its content provider. Turning to FIG. 4, therefore, a still further exemplary embodiment of the present invention is shown in which a document page (268) includes URIs (271) identifying digital objects (273), such as files or other resources, in a first storage location (908) for display in the document page (268). In embodiments of the kind illustrated in FIG. 4, storing (238) the member URI (236) typically includes storing (904) in a second location (902) in a file system (282) in the remote computer resource (232) the document page and all digital objects (273) identified by URIs (271) included within the document page (268), and changing (906) the member URI (236) identifying the network location of the document page so that the member URI identifies the second location (902) as the network location of the document page.

Take, for example, a web page at http://www.msnbc.com/. Such an example page contains many URIs identifying many other files for display within the page, including graphic image files, text files, and so on. A user sees upon the page a story interesting for later review, but the user knows that the page will change soon and the story will be gone. Modern browsers include the capability of saving of the files needed to display the page, including graphics, frames, style sheets, and so on, saving each referenced file in its original format, although such storage is static on the user's personal drive, not accessible by others, and not amenable to playback in sequence.

To gain the benefits of the present invention, the user sets a flag made available through the user interface (240) advising a group URI-enabled data communications client to store the page itself and all its referenced contents as a member URI The group URI-enabled data communications client is programmed through, for example, a plug-in, to change the member URI so that it identifies a second network, for example, http://www.foo.com/msnbc/, as the network location of the document page formerly identified as http://www.msnbc.com/. Now the member URI can, at any time, even after the original has been changed, be played back in sequence in a group URI, retaining its original content, playback occurring from anywhere in the world through any group URI-enabled data communications client.

Next we turn to consider a situation where a member URI identifies a first resource having embedded hyperlinks to other resources. Embedded hyperlinks, within a first resource, to other resources often empower a user to access, through invoking the hyperlink, information related to the first resource. By providing additional related information through an embedded hyperlink, a user is also empowered to experience the additional information optionally as the user desires or needs the additional related information.

Consider the example of a web page containing a scientific tutorial. The exemplary web page contains embedded hyperlinks to definitions of technical terms used within the scientific tutorial. In this example, the embedded hyperlinks are implemented through the use of HTML anchor elements. Each anchor element includes a target element identifying the location of a resource containing a definition of a particular technical term. Each anchor element also includes an anchor, which in this example is the particular technical term displayed in highlighting to indicate to a user the presence of an embedded hyperlink. The screen display area of the highlighted technical terms are sensitized to user interface operations to invoke the embedded hyperlinks. A reader of the scientific tutorial who knows the meaning of a particular technical term may not be benefited by invoking the embedded hyperlink to the resource containing the definition of that particular technical term. However, a reader who does not know the meaning of a particular technical term is benefited by invoking the embedded hyperlink to a resource containing the definition of that particular technical term.

Continuing with the same example, unless the scientific tutorial explains the function of the embedded hyperlinks, a reader will not know what resources are accessed by invoking the embedded hyperlinks. The reader sees a scientific tutorial with various terms highlighted. Many users, however, are familiar with the functionality of embedded hyperlinks and know without the need for explanation that invoking an embedded hyperlink will access resources related to the highlighted technical term.

The previous example demonstrates three benefits of embedded hyperlinks. The first benefit is that organizing resources accessible through embedded hyperlinks provides a hierarchical structure to the resources. That is, a second-tier of supporting resources is accessible through embedded hyperlinks within a first-tier resource. The second benefit is that users are empowered to access these second-tier resources optionally. The third benefit is that many users are already familiar with the hierarchical structure and optional access to resources that embedded hyperlinks provide.

There is a problem, however. Disabled users of group URI-enabled data communication clients may have difficulty physically invoking a small GUI interface control or manipulating a mouse to direct a cursor to a sensitized location on a display screen to invoke an embedded hyperlink. Otherwise able-bodied users may also have similar difficulty invoking embedded hyperlinks when these able-bodied users are occupied, such as, for example, when using a group URI-enabled data communications client installed on a PDA while driving a car. Some exemplary embodiments of methods according to the present invention address the difficulty faced by disabled users and occupied able-bodied users in invoking embedded hyperlinks.

FIG. 4A is a data flow diagram illustrating a method for administration of URIs in groups. The method of FIG. 4A includes creating (209) a group URI (254). In many example embodiments of the method of FIG. 4A, creating (209) a group URI (254) typically includes establishing a group URI name for the group URI, and concatenating the group URI name and a remote storage URI. In some embodiments of methods for administration of URIs in groups according to the present invention, establishing a group URI name involves automated name generation. In other embodiments of the method of FIG. 4A, establishing a group URI name includes prompting a user to enter a name and receiving the name as text through a user control such as a data entry field in a user interface.

The method of FIG. 4A includes creating (211) a first member URI (237) identifying a first resource (269). In many embodiments of the method of FIG. 4A, creating (211) a first member URI (237) identifying a first resource (269) includes creating the first member URI in response to at least one navigation event invoking a hyperlink to the resource at network location (233). ‘A navigation event invoking a hyperlink’ includes, for example, invocation of a browser ‘back’ button, a ‘forward’ button, an anchor, or entry of a URL or URI in an address field of a browser.

In some example embodiments of the method of FIG. 4A, creating (211) a first member URI (237) identifying a first resource (269) includes concatenating a member URI name with a URI identifying the location of the resource. In some examples of the method of FIG. 4A, the member URI is created by automatic name generation using for example, a random number generator. In other examples of the method of FIG. 4A, a user enters a member URI name through, for example, a user interface. In typical embodiments of the method of FIG. 4A, the URI concatenated with the member URI name identifies a resource at a network location, but in some other embodiments, the URI concatenated with the member URI name identifies resource stored in memory on computer on which the group URI enabled data communications client is installed. An example of a first member URI created by concatenating the member URI name and the URI identifying the resource is:

mbrURI1=http//www.google.com/

In the method of FIG. 4A creating (211) a first member URI (237) identifying a first resource (269) comprises creating (213) a first-tier member URI (217). In some example embodiments, creating the first-tier member URI includes data encoding a first-tier identifier in the first-tier member. An example of a member URI with data encoding identifying the member URI as a first-tier member URI is:

mbrURI1=http//www.google.com/&tier=1

The method of FIG. 4A includes identifying (252), within the first resource (269), an embedded hyperlink (272) to a second resource (267). The first resource (269) is the resource identified by the first member URI created in response to a navigation event. In the method of FIG. 4A, the first resource (269) has an embedded hyperlink to a second resource.

The method of FIG. 4A includes creating (254), in dependence upon the embedded hyperlink (272), a second member URI (241) identifying the second resource (269). In some examples of the method of FIG. 4A, an embedded hyperlink within a first resource includes an HTML anchor element. An HTML anchor element refers to a markup language element that identifies and implements the embedded hyperlink. A common example form of an anchor element is:

<a href=“\\SrvrX\DocY”> Press Here For Document Y </a>

This exemplary anchor element includes a start tag <a>, and end tag </a>. The exemplary anchor element includes an href attribute that identifies the target of the link as a document named ‘DocY’ on a web server named ‘SrvrX.’ The exemplary anchor element also includes an anchor. The “anchor” is the display text that is set forth between the start tag and the end tag. That is, in this example, the anchor is the text “Press Here For Document Y.” In typical usage, the anchor is displayed in highlighting, underscored, inverse, specially colored, or some other fashion setting it apart from other screen text and identifying it as an available embedded hyperlink. The “anchor element” is the entire markup from the start tag to the end tag.

To describe in more detail the steps of identifying (252), within the first resource (269), an embedded hyperlink (272) to a second resource (267) and creating (254), in dependence upon the embedded hyperlink (272), a second member URI (241) identifying the second resource (269), we turn now to FIG. 4B. FIG. 4B is a data flow diagram illustrating a method of identifying (252), within the first resource (269), an embedded hyperlink (272) to a second resource (267) and creating (254), in dependence upon the embedded hyperlink (272), a second member URI (241) identifying the second resource (269). In the method of FIG. 4B, identifying (252) a embedded hyperlink (272) within the first resource (269) comprises finding (752) a start tag (755) of an anchor element (754) and reading (756) a target (758) identifying the second resource (267). Again, a common example form of an anchor element is:

<a href=“\\SrvrX\DocY”> Press Here For Document Y </a>

In this example, the start tag is <a. In this example, ‘href’ identifies the target resource, Document Y, and the target location of target resource, SrvX.

In the method of FIG. 4B creating (254), in dependence upon the embedded hyperlink (272), a second member URI (241) identifying the second resource (269) comprises creating (760) the second member URI (241) in dependence upon the target (758). In some examples of the method of FIG. 4B, creating (760) a second member URI (241) in dependence upon the target includes concatenating a member URI name with a URI of the resource identified by the target. In some examples of the method of FIG. 4B the member URI name is created by automatic name generation using for example, a random number generator. In other examples of the method of FIG. 4B, a user enters a member URI name through, for example, a user interface. In typical embodiments of the method of FIG. 4A, the URI concatenated with the member URI name identifies a resource at a network location, but in some other embodiments, the URI concatenated with the member URI name identifies a resource stored in memory on a computer on which the group URI enabled data communications client is installed. An example of a first member URI created by concatenating the member URI name and the URI identifying the resource is:

mbrURI2=http//news.google.com/

We now return to the discussion of the method of FIG. 4A picking up with the step of creating (254), in dependence upon the embedded hyperlink (272), a second member URI (241) identifying the second resource (237). In the method of FIG. 4A creating (254), in dependence upon the embedded hyperlink (272), a second member URI (241) identifying the second resource (237) comprises creating (254) a second-tier member URI (219). A second-tier member URI is a supplemental member URI created in dependence upon an embedded hyperlink within the resource identified by a first-tier member URI. In some example embodiments of the method of FIG. 4A, creating a second-tier member UIR includes data encoding a second-tier identifier in the second-tier member URI. An example of a member URI with data encoding identifying the member URI as a second-tier member URI is:

mbrURI2=http://news.google.com/&tier=2

The method of FIG. 4A includes storing (256) the group URI (254), the first member URI (237), and the second member URI (241). In some examples of the method of FIG. 4A storing the group URI (254), the first member URI (237), and the second member URI (241) includes transmitting an HTTP POST request bearing encoding identifying the group URI, the first member URI, and the second member URI.

In the method of FIG. 4A storing (256) the group URI (254), the first member URI (237), and the second member URI (241) includes associating (360) the second-tier member URI (219) with the first-tier member URI (217). In the method of FIG. 4A associating (360) the second-tier member URI (219) with the first-tier member URI (217) results in an associated second tier member URI (362). Associating the second-tier member URI with the first-tier member URI from which the second-tier member UIR was created, links the second-tier member URI to the first-tier member URI so playback of the group URI replicates the original hierarchical nature between the resources identified by the fist tier URI and the second-tier URI. In some example embodiments of the present invention, associating the second-tier member URI and the first-tier member URI includes data encoding the group URI.

One way of data encoding the group URI is through the use of an ‘associate’ field that is a Boolean indicator. An example of a data encoded group URI that associates a second-tier member URIs named mbrURI2 and mbr URI3 with the first-tier member URI named mbrUIR1 is:

groupURIname=MyGrpURI-1&

mbrURI1=http//www.google.com/&tier=1 &

mbrUR12=http://news.google.com/&tier=2/&

associate=T&

mbrURI3=http://www.google.com/directory/&tier=2/&

associate=T&

. . .

In this example, the field ‘associate’ is a Boolean indication, that when set true, associates the previous second-tier member URI in the string with the closest preceding first-tier member URI in the string. In this example, the member URIs named mbrURI2 and mbrURI2 are associated with the previous first-tier member URI, mbrURI1.

In another example of data encoding a group URI to associate second-tier member URIs with a first-tier member URI, instead a Boolean indicator, the ‘associate’ field includes the name of an associated first-tier member URL The following is an example of a data encoded group URI that includes the name of the associated first-tier member URI in the ‘associate’ field.

groupURIname=MyGrpURI-1 &

mbrURI1=http//www.google.com/&tier=1 &

mbrURI2=http://news.google.com/&tier=2/&

associate=mbrURI1&

mbrURI3=http://www.google.com/directory/&tier=2/&

associate=mbrURI1

In this example, the associate field includes the name of the first-tier member URI associated with the member URI immediately preceding the associate field in the string. In the exemplary URI string, second-tier member URIs named mbrURI2 and mbrURI3 are associated with first-tier member URI named mbrUIR1.

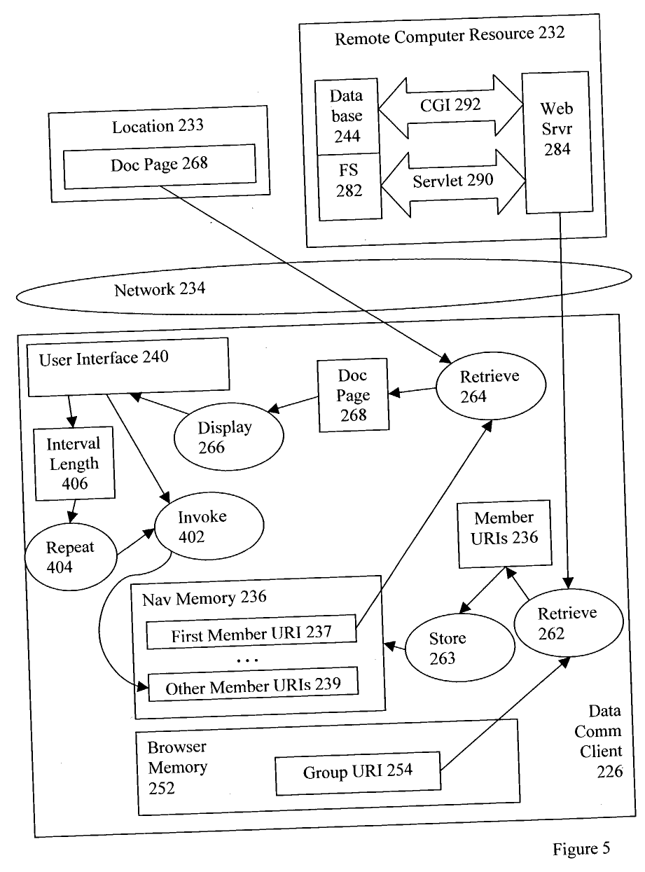

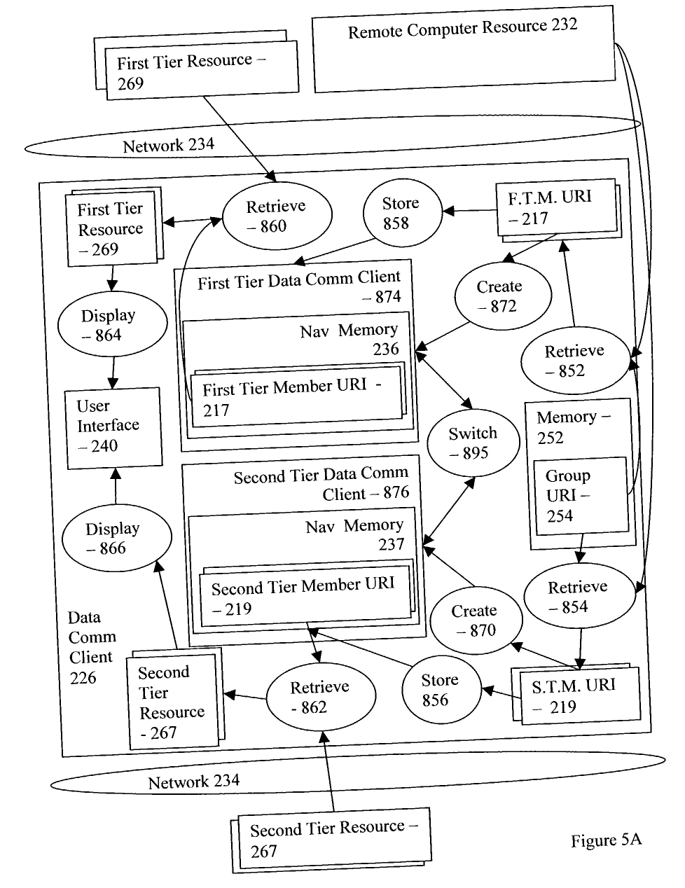

Turning now to FIG. 5, a still further exemplary embodiment of the invention is shown to include retrieving (262), in dependence upon the group URI, from the remote computer resource, the at least one member URI, the at least one member URI comprising a first member URI and one or more other member URIs. Consider the example group URI described above:

http://www.foo.com/cgi-bin/GuriScript.cgi?groupURIname=MyGrpURI-1

Again considering case of HTTP, in typical embodiments, in order to retrieve member URIs, such a group URI is transmitted to a web server (284) in an HTTP GET request message. The web server passes the request through a CGI interface (292) to a CGI script named GuriScript.cgi. The CGI script named GuriScript.cgi is fashioned in this example to retrieve from a database (244) and concatenate into a data encoded URI string, all the member URIs associated with the group URI. In other words, the group URI represents a kind of database query and the CGI script carries out the query, encodes and returns the results of the query, including a header describing the MIME type of the response as, for example, “application/groupURI.” The web server returns the member URIs in data encoded format in an HTTP response message, including a header with the MIME type. The member URIs in data encoded format have the form described earlier:

mbrURI1=http//www.google.com/&

mbrURI2=http//www.msnbc.com/&

mbrURI3=http//www.nsi.com/&

. . .

mbrURI376=http://www.ncsa.uiuc.edu/

Embodiments according to FIG. 5 typically include storing (263) the at least one member URI in data communications client navigation memory. As pointed out earlier, it is usual for a group URI to associate more than one member URI. When a typical example group URI-enabled data communications client of the present invention receives an HTTP response message with a MIME type set to “application/groupURI” and a data encoded list of member URIs, the data communications client is programmed to extract the member URIs from the data encoding and insert them into normal navigation memory so that they appear to data communications client to have already been navigated. That is, in the case of a browser, for example, the member URIs now appear in the pull down listing under the ‘forward’ button. In the case of a browser, a user can now use the browser's ‘forward’ and ‘back’ buttons to navigate through the member URLs, just as if they had been navigated one-by-one by hand and therefore listed in the browsers ‘back’/‘forward’ navigation history.

Such embodiments typically include retrieving (264) from a network location (233) a document page identified by the first member URI (237), displaying (266) the retrieved document page (268). That is, it is typical in embodiments of the present invention for a data communications client, after retrieving a group of member URIs, to go ahead and invoke the first one, retrieve the resource it identifies, and display the resource in the user interface. After the resource identified by the first member URI is displayed, it is usual for embodiments of data communications clients to invoke (402), in response to user manipulation of user controls in the user interface (240), one or more of the other member URIs (239). That is, a user can now navigate the other member URIs by use of user controls in a user interface, including for example, a browser's ‘back’ and ‘forward’ buttons.

In embodiments of the kind illustrated in FIG. 5, invoking one or more of the other member URIs often includes repeatedly (404) invoking in sequence one or more of the other member URIs (239) periodically at intervals having a display interval length (406). In effect, this is a kind of playback of the group URI, or rather, of the resources identified by the member URIs. In typical embodiments, the display interval length (406), and therefore the playback speed is set by a user through a user interface control, such as a date entry field in a user interface (240) and stored in computer memory, where it is changed by the user at will.

Until now our discussion of playback of a group URI has not included group URIs containing tiered member URIs. One way of administering tiered member URIs during playback is through the use of multiple instances of tier specific data communications clients. FIG. 5A is a data flow diagram of an exemplary method of administering playback of a group URI containing tiered member URIs. The method of FIG. 5A includes retrieving (852), in dependence upon the group URI (254), a plurality of first-tier member URIs (217) and retrieving (854), in dependence upon the group URI (254), a plurality of second-tier member URIs (219) associated with at least one first-tier member URIs (217). Again considering the case of HTTP, in typical embodiments, in order to retrieve the first-tier member URIs and the second tier-member URIs, a group URI is transmitted to a web server in an HTTP GET request message. The web server passes the request through a CGI interface to a CGI script. The CGI script retrieves from a database the group URI, the first-tier member URIs, and the second-tier member URIs. The CGI script concatenates into a data encoded URI string all the first-tier member URIs, all second-tier member URIs associated with each first-tier member URI, and the group URI. An example of such a data encoded URI string is:

groupURIname=MyGrpURI-1 &

mbrURI1=http//www.google.com/&tier=1&

mbrURI2=http://news.google.com/&tier-2/&

associate=mbrURI1&

mbrURI3=http://www.google.com/directory/&tier=2/&

associate=mbrURI1&

mbrUR14=http//www.ibm.com/&tie=1&

The exemplary data encoded URI string includes two first-tier member URIs named mbrURI1 and mbrURI4. The exemplary data encoded URI string includes two second-tier member URIs named mbrURI2 and mbrURI3. Both second-tier member URIs are associated with the same first-tier member URI named mbrURI1.

The method of FIG. 5A includes creating (872) an instance of a first-tier data communications client (874). The instance of the first-tier data communications client is created to display only the resources identified by the first-tier member URIs. The term first-tier data communications client is used for clarity of explanation. In many example embodiments, the first-tier data communications client is an instance of the group URI enabled data communications client.

The method of FIG. 5A includes creating (870) an instance of a second-tier data communications client (876). Again, the term second-tier data communications client is used for clarity of explanation. The second-tier data communications client displays a set of second-tier member URIs associated with a particular first-tier member URI. A separate instance of a second-tier data communications client is created for each first-tier member URI having associated therewith a set of second-tier member URIs. In many typical embodiments of the method of FIG. 5A, creating (870) an instance of a second-tier data communications client (876) is carried out by the group URI enabled data communications client that is programmed, through for example a plug-in, to create a separate instance of a second-tier data communications client upon receiving a data encoded group URI sting having encoding identifying second-tier member URIs associated with a first tier member URI. In many examples, of the method of FIG. 5A, the second-tier data communications client is a separate instance of the group URI enabled data communications client.

The method of FIG. 5A includes storing (858) the plurality of first-tier member URIs in navigation memory (236) of the first-tier data communications client (874). In many typical embodiments of the present invention, when a group URI-enabled data communications client of the present invention receives an HTTP response message with a MIME type set to “application/groupURI” and a data encoded list of first-tier member URIs, at least one of which has a set of associated second-tier member URIs, the group URI enabled data communications client is programmed to extract the first-tier member URIs, create an instance of a first-tier data communication client (874) and insert the first-tier member URIs into navigation memory so that they appear to the first-tier data communications client to have already been navigated. That is, in the case of a browser, for example, the first-tier member URIs now appear in the pull down listing under the ‘forward’ button of the instance of the first-tier browser. A user can now use the browser's ‘forward’ and ‘back’ buttons to navigate through the first-tier member URLs, just as if they had been navigated one-by-one by hand and are therefore, listed in the browsers ‘back’/‘forward’ navigation history. In alternative embodiments, instead of creating a separate instance for the first-tier data communication client, the group URI enabled data communications client extracts the first-tier member URIs from the data encoded group URI string and inserts them into the navigation memory of the group URI enabled data communications client, thus, in effect, becoming the first-tier data communications client.

The method of FIG. 5A includes storing (856) a plurality of second-tier member URIs in navigation memory (237) of the second-tier data communications client. In many example embodiments of the present invention, when a group URI-enabled data communications client of the present invention receives an HTTP response message with a MIME type set to “application/groupURI” and a data encoded list of second-tier member URIs associated with a first-tier member URI, the group URI enabled data communications client is programmed, through for example a plug-in, to extract the second-tier member URIs associated with a first-tier member URI create an instance of a second-tier data communications client for those second-tier member URIs, and insert the second-tier member URIs into navigation memory so that they appear to second-tier data communications client to have already been navigated. That is, in the case of a browser, for example, the second-tier member URIs now appear in the pull down listing under the ‘forward’ button of the second-tier browser. A user can now use the browser's ‘forward’ and ‘back’ buttons to navigate through the second-tier member URLs, just as if they had been navigated one-by-one by hand and are therefore, listed in the browsers ‘back’/‘forward’ navigation history.

The method of FIG. 5A includes retrieving (860) a plurality of first-tier resources (269) identified by the plurality of first-tier member URIs (217). The term ‘first-tier resource’ is used for clarity of explanation to mean a resource identified by a first-tier member URI. In the method of FIG. 5A, first-tier resources are displayed with an instance of the first-tier data communications client. Some embodiments of the method of FIG. 5A include retrieving one or more of the first-tier resources from a network location. Other embodiments of the method of FIG. 5A include retrieving one or more of the first-tier resources from memory in a computer on which the group URI enabled data communications client is installed.

The method of FIG. 5A includes retrieving (862) a plurality of second-tier resources (267) identified by the plurality of second-tier member URIs (219). The term ‘second-tier resource’ is used for clarity of explanation to mean a resource identified by a second-tier member URI. In the method of FIG. 5A, second-tier resources are displayed with an instance of the second-tier data communications client. Some embodiments of the method of FIG. 5A include retrieving one or more of the second-tier resources from a network location. Other embodiments of the method of FIG. 5A include retrieving one or more of the second-tier resources from memory in a computer on which the group URI enabled data communications client is installed.

The method of FIG. 5A includes displaying (864) the plurality of first-tier resources (269). The method of FIG. 5A includes displaying the plurality of first-tier resources with the instance of the first tier data communications client. In typical embodiments of the method of FIG. 5A, after the initial first-tier resource identified by the initial first-tier member URI is displayed, it is usual for embodiments of first-tier data communications clients to invoke, in response to user manipulation of user controls in a user interface, the first-tier member URIs in the order in which they are placed in the navigation memory of the first-tier data communications client to playback the first-tier member URIs. A user is empowered to navigate through one or more of the first-tier member URIs without invoking any second-tier URIs.

Embodiments according to FIG. 5A include switching (895) playback from the first-tier data communications client (874) to the second-tier data communications client. In typical embodiment of the method of FIG. 5A, the second-tier member URIs identify resources that are accessible through embedded hyperlinks within a first-tier member URI. Upon viewing a first-tier member URI containing the embedded hyperlinks, a user can instruct the group URI enabled data communication client to switch playback from the first tier member data communications client to the instance of the second tier data communications clients having in navigation memory the second-tier member URIs that identify the same resources accessible through the embedded hyperlinks in the first-tier member URI. In some examples, of the method of FIG. 5A, a user instructs the group URI enabled data communications client to switch playback from the first tier data communications client to the appropriate second-tier data communications client by invoking a control on a GUI interface such as, for example, ‘2^{nd} Tier’ button.

The method of FIG. 5A includes displaying (866) the plurality of second-tier resources (267). In the method of FIG. 5A includes displaying the plurality of second-tier resources with an instance of a second tier data communications client. In typical embodiments of the method of FIG. 5A, after the initial second-tier resource identified by the initial second-tier member URI is displayed, it is usual for embodiments of second-tier data communications clients to invoke, in response to user manipulation of user controls in a user interface, the second-tier member URIs in the order in which they are placed in the navigation memory of the second-tier data communications client to playback the second-tier member URIs. A user is empowered to view one or more of the second-tier member URIs.

Some examples of the method of FIG. 5A include switching playback from the second-tier data communications client back to the first-tier data communications client. In typical embodiments of the present invention, switching playback from the second-tier data communications client to the first-tier data communications client returns the user to the last displayed first-tier resource. In some examples, of the method of FIG. 5A, a user instructs the group URI enabled data communications client to switch playback from the second-tier data communications client to the first-tier data communications client by invoking a control on a GUI interface such as, for example, a ‘1^{st} Tier’ button.

Readers will notice that many exemplary embodiments in this disclosure are described in terms of CGI, but that is for explanation, not for limitation. In fact, remote access to resources through use of URIs can be accomplished well within the scope of the present invention by any remote access technology as will occur to those of skill in the art, including, for example, Java servlets.

In addition to other features described in this disclosure, many embodiments of the present invention include emailing the group URI, where emailing the group URI includes emailing only the group URI in the form of plain text. More specifically, typical embodiments include a facility, such as a user interface control, for calling an email client and passing to it for inclusion in the body of an email message a group URI in text form. The advantages are these. Modern email clients support hyperlinks. In typical modern email clients, the group URL appears to be a normal hyperlink in a display of a normal email message. It will be displayed as such and will be invocable by a user. When a user receives the email message bearing the group URL and invokes it as a hyperlink, the email client will invoke an appropriate data communications client, such as, in the case of an HTTP hyperlink, a browser, and the browser will attempt to retrieve and display the resource identified by the group URI.

Remember, at this point in our example, the group URI appears to the browser to be a standard hyperlink. In fact, it is. It is not until the data encoded member URIs are returned in a response message with a MIME type that the browser can know it is dealing with anything other than a normal download of a web page. If the browser is not a group URI-enabled data communications client of the present invention, then, upon receiving the response message, the browser will be confused. It will not know what to do with data encoded member URIs. If, however, the browser is a group URI-enabled data communications client of the present invention, then, upon receiving the response message, the browser will proceed to extract URIs, place them in browser navigation memory, and invoke the first one in accordance with the present invention. This illustrates one of the principal benefits of the present invention: that users are effectively empowered to email a program of many, many URIs in an email message comprising only one group URI, typically a short single line of text comprised simply of a group URI name and a remote storage URI.

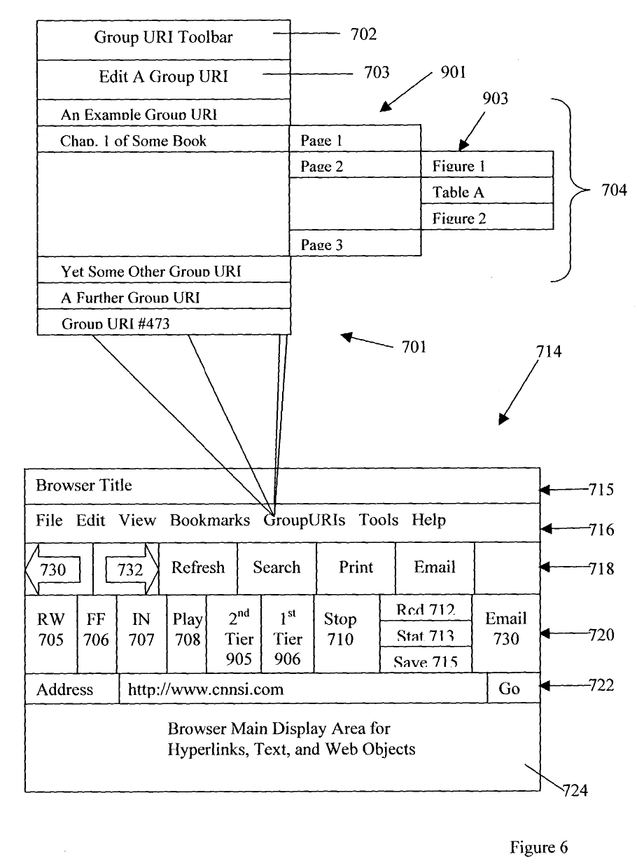

By way of further explanation, we turn to a further more particular exemplary embodiment in the form of a web browser with a plug-in, illustrated with the aid of FIG. 6. This example is described in terms of web browsers and email applications, HTML, HTTP, and email-oriented data communications protocols, although these details are for illustration and example only, not for limitation of the invention. FIG. 6 illustrates a browser (714) of the present invention, that is, in this example, a browser implemented by use of a plug-in as a group URI-enabled data communications client.

The browser of FIG. 6 has certain standard elements, including a title line (715), which typically says something like “Netscape Navigator,” “Microsoft Internet Explorer,” or “NCSA Mosaic.” In addition, the title line often may include a title from a header of a web page presently displayed in the main display area (724) of the browser. Standard browser elements include a horizontal pull down menu (716), although the menu entry “GroupURI” is nonstandard, an element of an embodiment of the present invention. Standard elements include a GUI toolbar (718) with a ‘back button’ (730), a ‘forward button’ (732), and buttons for refreshing the display, searching, printing, and send links or web pages in email. Standard browser features include also an address field and a ‘Go’ button to invoke a hyperlink typed into the address field (722).

Non-standard elements, that is, browser elements according to the present invention include the Group URL menu entry (726) mentioned above and a set of user controls implemented as GUI buttons in a group URI toolbar (720). Such user controls are implemented in various ways in various embodiments, including for example, as entries in a pull down menu or radio buttons in a dialog box. The group URI toolbar buttons include a Rewind button (705, a Fast Forward button (706), an Interval button (707), a Play button (708), a Stop button (710), a Record button (712), a 1^{st} Tier button (905), a 2^{nd} Tier button (906), and an Email button (730). All such user controls when invoked result in calls to software routines in a browser plug-in for administration of group URIs.

Invoking the GroupURI menu entry (726) calls a software routine programmed to display a group URI pull down menu (701). The group URI pull down menu includes a ‘Group URI Toolbar’ entry (702), an ‘Edit A Group URI’ entry (703), and group URI name entries (704). Invoking the Group URI Toolbar entry calls a software routine in the plug-in that displays the group URI toobar (720). Invoking the Edit A Group URI entry (703) calls a software routine in the plug-in that downloads from remote storage the member URIs of a selected group URI, displays the member URIs in a GUI edit window (not shown), and accepts user edits in the member URIs, and the stores member URIs back into remote storage. In this way, users are empowered to make changes in previously recorded groups of member URIs without necessarily repeating an entire recording process.

The group URI name entries (704) display group URI names from group URIs presently known to the browser, that is, group URIs presently stored in computer memory accessible to the browser. In the case of tiered member URIs, the pull down menu also shows the first-tier member URIs (901) of the group URI and their associated second-tier member URIs (903) in a manner that displays the hierarchy of the first and second-tier members. Invoking a group URI name entry from the group URI pull down menu calls a software routine that displays the group URI toolbar (720). The group URI name in the group URI name entry identifies a group URI, which the plug-in uses to download from remote storage a group of member URIs. The plug-in then disposes the member URIs in browser navigation memory so that the browser's Forward button (732) is active and, when invoked, will step the user to the next member URI in navigation memory. The plug-in then retrieves and displays or otherwise renders the resource identified by the first member URI in browser navigation memory. At this point, all the member URIs in the group are disposed in the browser ready for a user to view as the user wishes.

The user is empowered to simply step through the member URIs by mouseclicking on the browser's standard Forward button (732). The user can use the browser's standard Back button (730) to step back to previously viewed member URIs. Or the user can set the display interval length to a value of the user's choice and invoke the Play (720) to instruct the plug-in to step through the member URIs at a pace corresponding to the display interval length. Invoking the IN button (707) calls a software routine in the browser plug-in that displays a data entry field, prompts the user for a display interval length, and stores the display interval length in browser memory. Invoking the Play button (708) calls a browser plug-in software routine programmed to step through the member URIs, displaying each in turn, but waiting for the display interval length between displays.

More particularly, consider the example of a disabled user who wishes to read a book.

Such a user is empowered to download a chapter of the book with two mouseclicks, one on the GroupURI menu entry (726) and a second mouseclick on a group URI name entry in the group URI pull down menu (704) entitled, for example, “Chap. 1 of Some Book.” If the user knows his reading speed is about a page a minute, we assume for purposes of example that the display interval length is already set to 60 seconds. The first page of the book is automatically downloaded and displayed by the plug-in as soon as the user makes the second mouseclick on the group URI name entry. Now with only a third mouseclick on the Play button (720), the user causes the pages of the chapter, encoded as member URIs, to be displayed in sequence at one minute intervals. Three mouseclicks, which of course can be implemented with a variety of prosthetics depending on the extent of disability, and the user then reads the chapter with no further physical motion. Some plug-ins in some embodiments reduce the number of mouseclicks required to only two by automatically invoking the Play button, or the software routine corresponding to the Play button any time a group URI name entry (704) is invoked from the group URI pull down menu (701) and the display interval length is set to any length other than zero.

Invoking the Stop button (710) interrupts the operation of the software routine called by invocation of the Play button (708). When the Stop button is invoked, the Back button and the Forward button (730, 732) have their normal operations, so that the user can step back a page or two if desired, and then again press the Play button to continue automatic repetitive navigation through the group of member URIs.

Invoking the Rewind button (705), when a group of member URIs is loaded in navigation memory, calls a software routine programmed to load and display the resource identified by the first member URI in navigation memory and dispose the other member URIs for sequential access through the Forward button (732). In this example, the Fast Forward button (706) sets the display interval length to zero and then repetitively invokes a series of member URIs in turn, that is, churns through the member URIs as fast as the browser can download and display the resources identified by them. That is how Rewind and Fast Forward work in this example. In other embodiments, Rewind sets the interval and steps through member URIs quickly, while Fast Forward zips to the end. In other embodiments they both reset the interval and step quickly through member URIs, Fast Forward going forward through the member URIs in navigation memory, Rewind in the other direction.

In the case of group URIs including tiered members, invoking the 2^{nd} Tier button (905) calls a plug-in software routine to switch playback from a first-tier data communications client to a second tier data communications client empowering a user to view second-tier member UIRs. Invoking the 1^{st} Tier button (906) calls a plug-in software routine return playback from a second-tier data communications client to the first-tier data communications client returning the user to the first-tier member URIs.

Invoking the Record button (712) calls a plug-in software routine that prompts the user to enter a group URI name, concatenates the group URI name to a remote storage URI to form a group URI, records as the first of the member URIs the URI of the web page presently displayed by the browser, and, in response to subsequent navigation events resulting from the user's navigating among web sites on the web, records other member URIs in browser memory. In response to a navigation event comprising invoking an anchor, the plug-in reads the HREF attribute of the anchor element containing the anchor and records it as a member URL In response to a navigation event comprising a user's entering a URI into the browser Address field and mouseclicking the Go button, the plug-in records the URI so entered as a member URI. In response to a navigation event comprising mouseclicking the Back button (730), the plug-in records as a member URI a corresponding URI from navigation memory. In response to a navigation event comprising mouseclicking the Forward button (732), the plug-in records as a member URI a corresponding URI from navigation memory.

During record, on invocation of the Save button (715), the plug-in concatenates the group URI and the member URIs into a data encoded URI and transmits the data encoded URI for remote storage using an HTTP POST request message. Invocation of the Static Storage button (713) calls a software routine that toggles a static storage flag in browser memory. While the flag is set, the operation of the record routine is to store remotely at a second location all files needed to display a web page identified by a member URI and change the member URI to point to the second location. While the flag is reset, the operation of the record routine is to store the original member URI only.

During record, the operation of the software routine called upon invocation of the Stop button is to stop the record routine. The user is then empowered to navigate the web for a while and the invoke Record (712) again to continue recording under the same group URI. Or the user can Save (715), the present URI and begin recording another. The group of member URIs so recorded can be Saved (715) and later Edited (703), or Edited (703) and later Saved (715), or both, which begins to show the reader some of the power and flexibility of embodiments of the present invention.

Invoking the Email button (730) calls a plug-in software routine that reads from browser memory a selected member URI, calls an email application, such as Microsoft Outlook, and passes the member URI to the email application as message body text. In this example, a user selects a member URI by selecting its member URI name (704) from the pull down menu (701). Then the plug-in, when the Email button in invoked, identifies the group URI in browser memory by matching it with the selected group URI name and passes the group URI so identified to the email application. Other embodiments prompt the user for a group URI name when the Email button in invoked. Persons of skill in the art will think other ways to select a particular group URI for passing to an email application, and all such ways are well within the scope of the present invention.

It will be understood from the foregoing description that various modifications and changes are made and will be made in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method for administration of URIs in groups, the method comprising:
creating a group URI;
creating a first member URI identifying a first resource;
identifying, within the first resource, an embedded hyperlink to a second resource;
creating, in dependence upon the embedded hyperlink, a second member URI identifying the second resource; and
storing the group URI, the first member URI, and the second member URI.

2. The method of claim 1 wherein creating a first member URI identifying a first resource comprises creating a first-tier member URI, and wherein creating, in dependence upon the embedded hyperlink, a second member URI identifying the second resource comprises creating a second-tier member URI.

3. The method of claim 2 wherein storing the group URI, the first member URI, and the second member URI comprises associating the second-tier member URI with the first-tier member URI.

4. The method of claim 3 further comprising:
retrieving, in dependence upon the group URI, a plurality of first-tier member URIs;
retrieving, in dependence upon the group URI, a plurality of second-tier member URIs associated with at least one first-tier member URI;
retrieving a plurality of first-tier resources identified by the first-tier member URIs;
retrieving a plurality of second-tier resources identified by the second-tier member URIs;
displaying the first-tier resources; and
displaying the second-tier resources.

5. The method of claim 4 comprising creating an instance of a first-tier data communications client and creating an instance of a second-tier data communications client.

6. The method of claim 5 comprising storing the plurality first-tier member URIs in navigation memory of the first-tier data communications client and storing the plurality of second-tier member URIs in navigation memory of the second-tier data communications client.

7. The method of claim 1 wherein identifying an embedded hyperlink within the first resource comprises finding a start tag of an anchor element and reading a target identifying the second resource.

8. A system for administration of URIs in groups, the system comprising:
means for creating a group URI;
means for creating a first member URI identifying a first resource;
means for identifying, within the first resource, an embedded hyperlink to a second resource;
means for creating, in dependence upon the embedded hyperlink, a second member URI identifying the second resource; and
means for storing the group URI, the first member URI, and the second member URI.

9. The system of claim 8 wherein means for creating a first member URI identifying a first resource comprises means for creating a first-tier member URI, and wherein means for creating, in dependence upon the embedded hyperlink, a second member URI identifying the second resource comprises means for creating a second-tier member URI.

10. The system of claim 9 wherein means for storing the group URI, the first member URI, and the second member URI comprises means for associating the second-tier member URI with the first-tier member URI.

11. The system of claim 10 further comprising:
means for retrieving, in dependence upon the group URI, a plurality of first-tier member URIs;
means for retrieving, in dependence upon the group URI, a plurality of second-tier member URIs associated with at least one first-tier member URI;
means for retrieving a plurality of first-tier resources identified by the first-tier member URIs;
means for retrieving a plurality of second-tier resources identified by the second-tier member URIs;
means for displaying the first-tier resources; and
means for displaying the second-tier resources.

12. The system of claim 11 comprising means for creating an instance of a first-tier data communications client and means for creating an instance of a second-tier data communications client.

13. The system of claim 12 comprising means for storing the plurality first-tier member URIs in navigation memory of the first-tier data communications client and means for storing the plurality of second-tier member URIs in navigation memory of the second-tier data communications client.

14. The system of claim 8 wherein means for identifying an embedded hyperlink within the first resource comprises means for finding a start tag of an anchor element and means for reading a target identifying the second resource.

15. A computer program product for administration of URIs in groups, the computer program product comprising:
a recording medium;
means, recorded on the recording medium, for creating a group URI;
means, recorded on the recording medium, for creating a first member URI identifying a first resource;
means, recorded on the recording medium, for identifying, within the first resource, an embedded hyperlink to a second resource;
means, recorded on the recording medium, for creating, in dependence upon the embedded hyperlink, a second member URI identifying the second resource; and
means, recorded on the recording medium, for storing the group URI, the first member URI, and the second member URI.

16. The computer program product of claim 15 wherein means, recorded on the recording medium, for creating a first member URI identifying a first resource comprises means, recorded on the recording medium, for creating a first-tier member URI, and wherein means, recorded on the recording medium, for creating, in dependence upon the embedded hyperlink, a second member URI identifying the second resource comprises means, recorded on the recording medium, for creating a second-tier member URI.

17. The computer program product of claim 16 wherein means, recorded on the recording medium, for storing the group URI, the first member URI, and the second member URI comprises means, recorded on the recording medium, for associating the second-tier member URI with the first-tier member URI.

18. The computer program product of claim 17 further comprising:
means, recorded on the recording medium, for retrieving, in dependence upon the group URI, a plurality of first-tier member URIs;
means, recorded on the recording medium, for retrieving, in dependence upon the group URI, a plurality of second-tier member URIs associated with at least one first-tier member URI;
means, recorded on the recording medium, for retrieving a plurality of first-tier resources identified by the first-tier member URIs;
means, recorded on the recording medium, for retrieving a plurality of second-tier resources identified by the second-tier member URIs;
means, recorded on the recording medium, for displaying the first-tier resources; and
means, recorded on the recording medium, for displaying the second-tier resources.

19. The computer program product of claim 18 comprising means, recorded on the recording medium, for creating an instance of a first-tier data communications client and means, recorded on the recording medium, for creating an instance of a second-tier data communications client.

20. The computer program product of claim 19 comprising means, recorded on the recording medium, for storing the plurality first-tier member URIs in navigation memory of the first-tier data communications client and means, recorded on the recording medium, for storing the plurality of second-tier member URIs in navigation memory of the second-tier data communications client.

21. The computer program product of claim 15 wherein means, recorded on the recording medium, for identifying an embedded hyperlink within the first resource comprises means, recorded on the recording medium, for finding a start tag of an anchor element and means, recorded on the recording medium, for reading a target identifying the second resource.
